(19) United States
(12) Patent Application Publication
(10) Pub. No.: US 2026/0312161 A1
(43) Pub. Date: Oct. 8, 2026

(54) IN SITU ELECTROCHEMICAL HYDROGEN PEROXIDE GENERATION FOR HYDROMETALLURGICAL LITHIUM-ION BATTERY RECYCLING

(71) Applicant: The Trustees of Columbia University in the City of New York, New York, NY (US)

(72) Inventors: Richard MAY, New York, NY (US); Dan Steingart, New York, NY (US); Brandon DYE, New York, NY (US)

(21) Appl. No.: 19/462,227

(22) Filed: Jan. 28, 2026

Related U.S. Application Data
(63) Continuation of application No. PCT/US2024/039806, filed on Jul. 26, 2024.
(60) Provisional application No. 63/516,313, filed on Jul. 28, 2023.

(51) Int. Cl. H01M 10/54; C25B 1/30; C25B 11/042; C25C 1/08; C25C 1/10; C25C 7/02; H01M 10/0525

(52) U.S. Cl. CPC H01M 10/54; C25B 1/30; C25B 11/042; C25C 1/08; C25C 1/10; C25C 7/02; H01M 10/0525

(57) ABSTRACT

A method, comprising: in the presence of an acid, applying a current between a first electrode and a second electrode so as to form an amount of hydrogen peroxide in situ so as to give rise to a digesting solution that comprises hydrogen peroxide and the acid; contacting the digesting solution and a metallic composition comprising a metal so as dissolve at least some of the metal comprised in the metallic composition, the metal optionally being a transition metal; and collecting at least some of the metal dissolved from the metallic composition. A system, comprising: a container; a first electrode and a second electrode, the first electrode and the second electrode being disposed within the container, at least one of the first electrode and the second electrode comprising PbO₂; and an amount of acid disposed in the container.

### RELATED APPLICATIONS

The present application is a bypass continuation of U.S. National Phase Application No. PCT/US2024/039806, “In Situ Electrochemical Hydrogen Peroxide Generation For Hydrometallurgical Lithium-Ion Battery Recycling” (filed Jul. 26, 2024); which claims priority to and the benefit of U.S. patent application no. 63/516,313, “In Situ Electrochemical Hydrogen Peroxide Generation For Hydrometallurgical Lithium-Ion Battery Recycling” (filed Jul. 28, 2023). All foregoing applications are incorporated herein by reference in their entireties for any and all purposes.

### TECHNICAL FIELD

The present disclosure relates to the field of hydrometallurgical recycling.

### BACKGROUND

Engineered materials, from steel to semiconductors to battery active components, can begin with either minerals extracted from the Earth or recycled inputs from end-of-life (EOL) devices. Both classes of input material must be separated and purified to standards for the given application. Structural metals generally require less than 100 PPM of unintended dopants, and semiconductor and battery materials require under 1 PPM of labile impurities. Mineral extraction and recycling processes evolved over millennia to achieve these goals, and the convergence of climate, societal and economic concerns now warrants reducing the environmental impact of extraction and recycling while reducing cost.

Mineral refinement is a subset of the field of separation, where the atoms to be separated start in the solid phase. Ores (from the earth) and weathered engineered materials—such as scrap)—are typically oxidized, which can be in the form of metal oxides, metal sulfates, metal phosphates, or metal sulfides, as examples. The first order of refinement can be, in some instances, be to separate oxygen and sulfur species from the metal ion.

Pyrometallurgy (“pyro”) is perhaps the oldest refinement strategy and is still the most common. Pyro involves heating a material to trigger thermally driven decomposition and separation, often aided by a reducing or oxidizing species to accelerate the process. Fe₂O₃ (s) reduction to Fe(s) is perhaps the most famous and ubiquitous pyro process, producing 2 GT of iron for steel every year worldwide. Pyro processes are still standard for battery production in some geographies because of the processes'low cost, but these costs do not always fully account for environmental damage.

Hydrometallurgy involves using a caustic solvent—which can be H₂SO₄ (aq) -to dissolve oxidized species with an added oxidizing or reducing agent. For example, in copper extraction, H₂SO₄ interacts with naturally present acid-stable bacteria to trigger natural Fe²⁺/Fe³⁺ oxidation-reduction cycles that greatly accelerate ore dissolution. But even with acceleration, the residence times for these processes can be on the order of 90 days, which means that leaching occupies a significant land area exposed to highly corrosive solvents for long periods. Accordingly, there is a long-felt need in the field for improved processing methods.

### SUMMARY

So-called “overclocking” dissolution via aggressive chemistry is a relatively nascent approach at scale. A formula useful to accelerate dissolution is the combination of H₂SO₄ (aq) and H₂O₂ (aq) (dubbed “piranha” because it “eats everything”). Piranha solution is the “reference standard” for black mass digestion in battery recycling. While its use began because H₂SO₄ (aq) is known to dissolve oxides, and in combination with H₂O₂ (aq), the foregoing is also a known organic digester, and the combination also digested oxide materials at a higher rate than H₂SO₄ (aq) alone. H₂O₂ (aq), in the presence of ions in a solution capable of multiple valences, can form the exceptionally oxidizing OH· radical via the Fenton and Fenton-like reactions.

The Fenton reaction is a reaction where H₂O₂ (aq) combines with a small amount of iron (<100 ppm) in solution to produce OH· radicals. OH· radicals are exceptional oxidizers, second only to pure F₂ (g) amongst earth-abundant reagents. Unlike halides and halogens, when OH· reacts, it forms OH⁻ and then quickly combines with free protons in acid to form H₂O. Fenton reaction loops are genuinely green reagents, as the only byproduct is water. As an example, the textile industry uses the reaction to both bleach clothing and remove organic stains.

There are several ways to introduce H₂O₂ (g) into the Fenton reaction. The electro-Fenton process produces H₂O₂ by first using a depolarized electrolysis unit to produce H₂ and O₂ on demand from clean water, then recombining to form H₂O₂ (aq), finally feeding the H₂O₂ to an iron-bearing stream. In a depolarized H₂O₂ (aq) generator, H₂ (g) is formed at the cathode and allowed to migrate to the anode, where it interrupts O₂ (g) formation, instead forming H₂O₂ (aq). Alternatively, O₂ (g) generated at the anode can be depolarized at the cathode for the same effect.

Generally, the H₂O₂ is generated separately from the iron-bearing stream as the H₂O₂ would be converted instantly to OH·. In standard electro-Fenton processes, instant radical formation can have two adverse outcomes:
The OH· does not last long enough to attack the organics and materials of choice
The OH· attacks the fragile organic membranes and precious metal catalysts of the electrolyzer.

While iron is the typical homogenous catalyst for the Fenton and electro-Fenton processes, one can use “Fenton-like” transition metal catalysts such as Ni, Mn, Co, and others that have similar (if not as facile) production of OH· in the presence of H₂O₂. While Fe²⁺ is a suitable catalyst for Fenton reactions, Fe²⁺ is also but one option for such reactions. In recycling and pure mineral digestion, the quantities of H₂O₂ (g) required are ultimately not economical, and standard production routes of H₂O₂ are carbon intensive. Further, transport and mixing in piranha can be dangerous. Accordingly, there is a long-felt need in the art for improved methods of forming piranha solution as well as improved methods for hydrometallurgical recycling. In particular, existing hydrometallurgical recycling of lithium-ion batteries typically occurs under acidic, oxidative conditions using sulfuric acid and hydrogen peroxide reagents. These reagents are classified as oxidizers by the Occupational Safety and Health Administration, subject to unique transportation regulations.

In meeting the described needs, the disclosed technology provides, inter alia, an in-situ method to generate hydrogen peroxide in the extraction process of spent batteries using electrochemical methods. The peroxide can be produced, for example, via Pb high-surface area mesh electrodes in the greywater of the leaching reactor, using—for example—200 mA/cm² of current densities and overpotentials of <5V. Compared to existing technologies, these electrodes are comparatively stable in the impurity-laden graywater generally present during the leaching of spent batteries. Additionally, current systems require special reactors and apparatuses to maintain peroxide production, while this technology allows for H₂O₂ production modulation by tuning the current density and applied voltage. This technology has numerous applications, namely in mineral and rare element recovery, recycling of batteries, and also mining hydrometallurgical processes.

In one aspect, the present disclosure provides a method, comprising: in the presence of an acid, applying a current between a first electrode and a second electrode so as to form an amount of hydrogen peroxide in situ so as to give rise to a digesting solution that comprises hydrogen peroxide and the acid; contacting the digesting solution and a metallic composition comprising a metal so as dissolve at least some of the metal comprised in the metallic composition, the metal optionally being a transition metal; and collecting at least some of the metal dissolved from the metallic composition.

Also provided is a system, comprising: a container; a first electrode and a second electrode, the first electrode and the second electrode being disposed within the container, at least one of the first electrode and the second electrode comprising PbO₂; and an amount of acid disposed in the container.

Further provided is a method, comprising: forming hydrogen peroxide in situ and contacting the hydrogen peroxide and an acid to form a digesting solution; contacting the digesting solution and a metallic composition that comprises a metal so as to dissolve the metal, the metal optionally being a transition metal; and collecting at least some of the dissolved metal.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1. Left, exemplary of operation of the disclosed technology. Right, an example of the successful production of piranha on demand in an example reactor via the consumption of H₂O₂ in 1 M H₂SO₄ (aq)/0.1 M FeSO₄ (aq).

FIG. 2. Left, digesting LiNi_{0.8}Mn_{0.1}Co_{0.1}O₂ in 8M H₂SO₄ (aq). Note that digestion is incomplete after 24 hours. Right, the same battery sample in 2M H₂SO₄ (aq)+14% H₂O₂ (aq); digestion complete in less than 1 hour.

FIG. 3 provides experimental results showing generation and consumption of hydrogen peroxide according to the disclosed technology (left) and an example system according to the present disclosure (right).

FIG. 4 provides example results from a system according to the present disclosure in which the nickel manganese cobalt (NMC) powder being processed is in contact with one of the Pb electrodes of the system.

FIG. 5 provides example results from a system according to the present disclosure in which the NMC powder being processed is in contact with one of the Pb electrodes of the system and a separator is disposed between the two electrodes of the system.

FIG. 6 provides example results from a system according to the present disclosure in which the NMC powder being processed is separated from the Pb electrodes of the system and a separator also is disposed between the two electrodes of the system.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments of aspects can be combined with any part or parts of any one or more other embodiments or aspects.

In the presence of a mild-to-strong acid (for example, H₂SO₄) solution, one can generate H₂O₂ (aq) with an electro-Fenton-like process in the presence of Fe²⁺ ions and other battery-relevant transition metals without destroying the reactor components and dissolve refractory species of choice (e.g., battery cathodes and ores). The Fe²⁺ ions can be present

Pb(s) is mainly insoluble in H₂SO₄ (for example, <3 PPM @ 60° C.) under oxidizing conditions, where it forms a dense film of PbO₂ rather than dissolving. The reduction of PbO₂ (s) in the presence of H₂SO₄ (aq) produces PbSO₄ (s). Without being bound to any particular theory or embodiment, failure of PbO₂ electrodes is due not to chemical dissolution but rather to mechanical shedding.

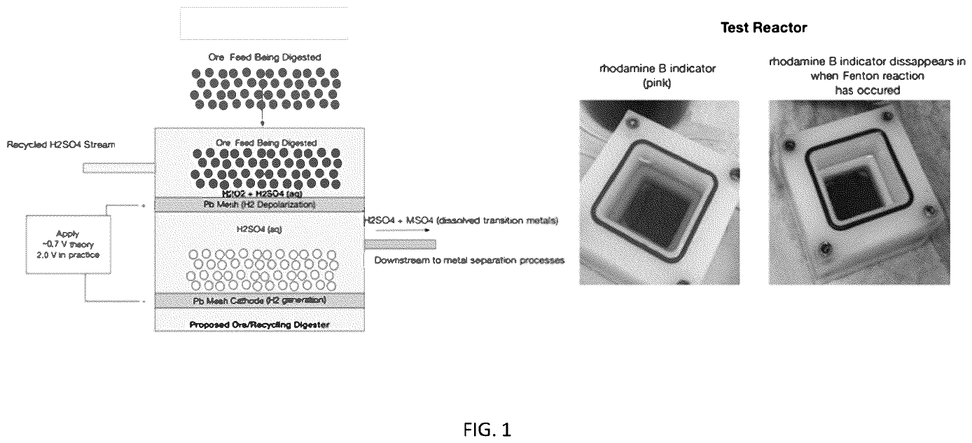

PbSO₄ (s) is prevented upon reduction of PbO₂ (s) in the presence of redox able ions such as Fe²⁺/Fe³⁺ and, for example, Ni³⁺/Ni⁴⁺, Mn²⁺/Mn³⁺/Mn⁴⁺, and Co³⁺/Co⁴⁺. Without being bound to any particular theory or embodiment, this means that Fenton active components, in the presence of PbO₂ (s), stabilize PbO₂ (s) against PbSO₄ (s) shedding while forming rock-digesting radical OH·. FIG. 1 provides a reactor design (left) and also indication the reactor has produced piranha (right).

The symbiotic stabilization of PbO₂ (s) electrodes in the presence of battery ions allows us the ability to create H₂O₂ (aq) in a reactor with H₂SO₄ (aq) on demand, where the battery metal ion itself is the Fenton and Fenton-like catalyst. The production of H₂O₂ (aq) in the presence of these ions leads to OH·, which in turn accelerates the dissolution of the input mass; the input mass can be, for example, ore or scrap battery cathode material.

In illustrative experiments, for over 100 hours of operating a process according to the present disclosure, there was:
No Pb (aq) detectable in solution (meaning PbO₂ (s) is neither dissolving nor exfoliating)
Apparent dissolution of Ni, Co, and Mn from the active materials when the reactor is “on.”
Minor dissolution of Ni, Co, and Mn when the reactor is off

Without being bound to any particular theory, the foregoing can be understood to indicate that one can dissolve input material via an electro-Fenton-like generated radical attack. The disclosed process thus has a range of applications, including, for example, green ore and scrap digestion at scale.

In particular, it has been shown that the disclosed process can produce meaningful quantities of H₂O₂ (aq) in the presence of PbO₂, standard leaching acids (i.e. H₂SO₄), and transition metal battery materials; this is shown in FIG. 1.

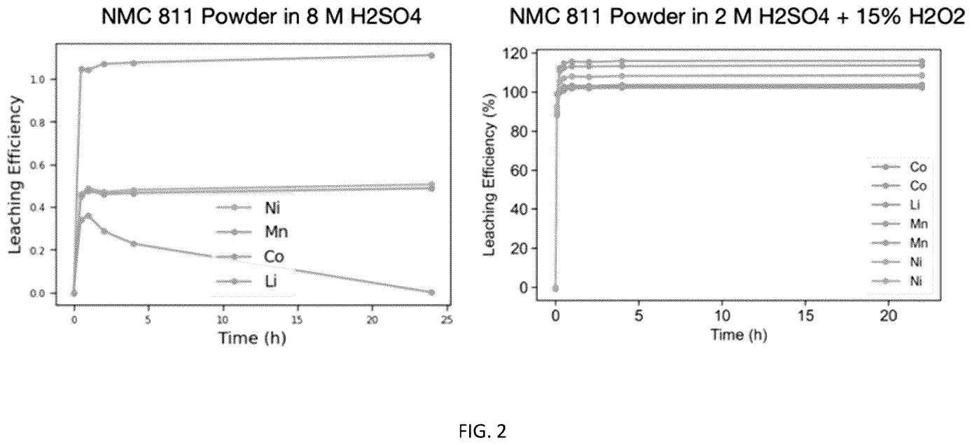

As shown, using standard piranha, one can dissolve ores and battery black-mass at competitive rates; such rates can be on the order of minutes or hours instead of on the order of days or weeks (FIG. 2). This digestion can be executed in a reaction without chemical separation membranes.

### Greywater Looping

Current processes for mining minerals and recycling batteries are water-intensive. Leach pits lose significant amounts of water to evaporation, and external H₂O₂/H₂SO₄ mixtures require DI clean water. The disclosed process reduces residence time from months to hours (or better) and does not require clean water, as the process can operate in greywater.

### Additive Reagents

Unlike the traditional piranha process, the disclosed process can produce H₂O₂ within the digestion reactor with electricity. This reduces upstream greenhouse gas (GHG) emissions associated with H₂O₂ production as well as safety challenges in transporting and mixing piranha solution. Because one can use the transition metal ions as Fenton and Fenton-like catalysts, one need not necessarily add or filter other metal contaminants.

### Operational Cost

The disclosed process can be performed without one or both of membranes and precious metal catalysts. Instead, the operating input can be the electricity that drives the H₂O₂ (aq) formation. Thus, the disclosed technology can compete with or even surpass the operating expense advantage of equivalent pyro processes.

### Aspects

The following Aspects are illustrative only and do not limit the scope of the present disclosure or the appended claims. Any part or parts of any one or more Aspects can be combined with any part or parts of any one or more other Aspects.

Aspect 1. A method, comprising: in the presence of an acid, applying a current between a first electrode and a second electrode so as to form an amount of hydrogen peroxide in situ so as to give rise to a digesting solution that comprises hydrogen peroxide and the acid; contacting the digesting solution and a metallic composition comprising a metal so as dissolve at least some of the metal comprised in the metallic composition, the metal optionally being a transition metal; and collecting at least some of the metal dissolved from the metallic composition. The digesting solution can, for example, be formed in the presence of the metallic composition.

Sulfuric acid is considered a particularly suitable acid for the disclosed technology. It should be understood, however, that the disclosed technology can operate using acids other than sulfuric acid. For example, any one or more of hydrochloric, hydrobromic, hydroiodic, perchloric, chloric, sulfuric, and nitric acid can be used.

Aspect 2. The method of Aspect 1, wherein at least one of the first electrode and the second electrode comprises PbO₂. As described herein, Pb-containing electrodes are considered especially suitable, but also are not required.

Aspect 3. The method of any one of Aspects 1-2, wherein the acid comprises sulfuric acid. As described elsewhere herein, sulfuric acid is considered a particularly suitable acid, but it should be understood, however, that the disclosed technology can operate using acids other than sulfuric acid. For example, any one or more of hydrochloric, hydrobromic, hydroiodic, perchloric, chloric, sulfuric, and nitric acid can be used.

Aspect 4. The method of any one of Aspects 1-3, wherein the metal comprises any one or more of nickel, manganese, and cobalt. The foregoing listing is not exhaustive, however, and iron can also be used in some embodiments. It should be understood that any one or more of Fe²⁺/Fe³⁺, Ni³⁺/Ni⁴⁺, Mn²⁺/Mn³⁺/Mn⁴⁺, and Co³⁺/Co⁴⁺ ions can be present. Such ions can be present in the metallic composition; such ions can also be provided separately.

Aspect 5. The method of any one of Aspects 1-4, further comprising collecting the metallic composition from a battery. The collecting can be accomplished by, for example, harvesting the metallic composition from used batteries.

Aspect 6. The method of any one of Aspects 1-5, wherein fluid motion is restricted (i) between the metallic composition and one of the first and second electrodes, (ii) between the first and second electrodes, or both (i) and (ii). Fluid motion can be restricted by, for example, a pervious medium—such as a membrane—or other fluid restrictor.

Aspect 7. The method of Aspect 6, wherein a pervious medium restricts the fluid motion. Such a medium can be a membrane, filter paper, a mat, a wool, and the like.

Aspect 8. The method of any one of Aspects 1-7, wherein the method is performed under such conditions that the first and second electrodes remain essentially structurally intact during performance of the method.

Aspect 9. The method of any one of Aspects 1-8, wherein the method is performed in a continuous manner.

Aspect 10. A system, comprising: a container; a first electrode and a second electrode, the first electrode and the second electrode being disposed within the container, at least one of the first electrode and the second electrode comprising PbO₂; and an amount of acid disposed in the container.

Aspect 11. the system of Aspect 10, wherein the acid comprises sulfuric acid.

Aspect 12. The system of any one of Aspects 10-11, further comprising an amount of a metallic composition disposed in the container. The metallic composition can be comprised in a feed to the system; such a feed can be an ore, scrap, battery parts, and the like. The metallic composition can also be present within the system, for example as a metal that is present or otherwise pre-loaded in the system.

Aspect 13. The system of Aspect 12, wherein the metallic composition comprises a transition metal.

Aspect 14. The system of any one of Aspects 12-13, further comprising a pervious medium (i) between the metallic composition and one of the first and second electrodes, (ii) between the first and second electrodes, or both (i) and (ii). Pervious media are described elsewhere herein; such media can be, for example, membranes, filter paper, mats, wools, and the like. Such a medium can be porous, fibrous, and the like.

Aspect 15. The system of any one of Aspects 10-14, further comprising an outlet for communicating dissolved material evolved in the container. The outlet can be in fluid communication with a metal separation location; metal separation can be performed according to methods known in the art.

Aspect 16. A method, comprising: forming hydrogen peroxide in situ and contacting the hydrogen peroxide and an acid to form a digesting solution; contacting the digesting solution and a metallic composition that comprises a metal so as to dissolve the metal, the metal optionally being a transition metal; and collecting at least some of the dissolved metal.

Aspect 17. The method of Aspect 16, wherein the digesting solution is free or essentially free of exogenous hydrogen peroxide. This is not, however, a requirement. The digesting solution can include the hydrogen peroxide formed in situ as well as hydrogen peroxide that occurs naturally in the solution.

Aspect 18. The method of any one of Aspects 16-17, wherein forming the hydrogen peroxide in situ is effected electrochemically by applying a current between first and second electrodes, the first and second electrodes comprising PbO₂.

Aspect 19. The method of any one of Aspects 16-18, wherein the metallic composition is obtained from a battery. The metal can be, for example, any one or more of nickel, manganese, and cobalt.

Aspect 20. The method of any one of Aspects 16-19, wherein the dissolved metal comprises any one or more of nickel, manganese, and cobalt.

FIG. 1 provides an example depiction of the disclosed technology. As shown in the left panel of FIG. 1, the disclosed technology can include providing a feed-such as an ore, battery components, and the like-to a reactor. The reactor can include a region in which the feed is contact with a digesting solution, for example, piranha solution. The hydrogen peroxide can, as described, be formed in situ. In this way, one can form the digesting solution in situ without the need to transport the hydrogen peroxide to the use location.

As shown, the reactor can include electrodes; an electrode can be present as a mesh or in other pervious form, although this is not a requirement. An electrode can comprise PbO₂; in some embodiments, an electrode can consist of PbO₂. A potential can be applied to the electrodes; such a potential can be, for example, from −5 V to 5 V, for example from −0.8 V to 2 V. Metal dissolved from the feed can be communicated from the reactor for further processing; as shown in FIG. 1, dissolved metal (M) from the feed can be communicated from the reactor for further processing, such as for metal separation. Also as shown, acid—which can be recycled acid—can be provided to the reactor. Such recycled acid can be separated from the metal/acid solution that is communicated from the reactor for further processing.

The reactor can have present a metal—for example, any one or more of Fe, Ni, Li, Mn, and Co—that supports production of OH· in the presence of H₂O₂. Such a metal can be present within the reactor; such a metal can also be comprised in the feed to the reactor. The reactor can, as described, be operated to form H₂O₂ in situ and then form OH· from the H₂O₂ in the presence of acid, thereby facilitating the extraction of metals-such as transition metals-from the feed to the reactor. As described, H₂O₂ can be produced from fresh water fed to the reactor, but the H₂O₂ can also be produced from greywater, for example the greywater that results during the leaching of spent batteries. H₂O₂ can also be produced from a carrier fluid—such as greywater or other fluid—that carries the feed into the reactor. A reactor can be operated in a batch mode, a semi-batch mode, or even in a continuous mode.

Although FIG. 1 depicts the presence of Pb electrodes, it should be understood that this is exemplary only and that other materials besides Pb can be used. Similarly, although FIG. 1 depicts the use of sulfuric acid, other acids can be used with and/or in place of sulfuric acid, as it is not a requirement that sulfuric acid be present.

FIG. 2. Left, digesting LiNi_{0.8}Mn_{0.1}Co_{0.1}O₂ in 8M H₂SO₄ (aq). Note that digestion is incomplete after 24 hours. Right, the same battery sample in 2M H₂SO₄ (aq)+14% H₂O₂ (aq); digestion complete in less than 1 hour.

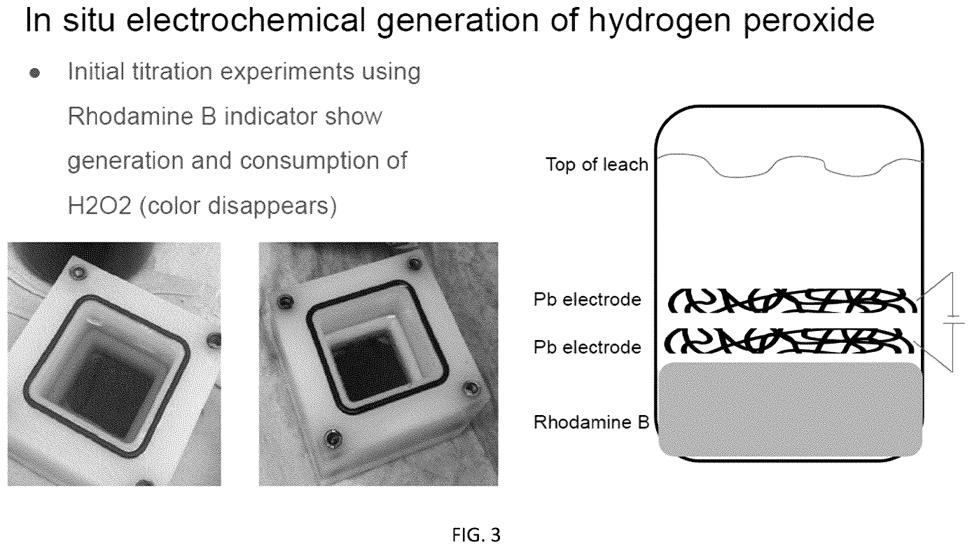

FIG. 3 provides experimental results showing generation and consumption of hydrogen peroxide according to the disclosed technology (left) and an example system according to the present disclosure (right). Ass shown, Rhodamine B—or other indicator—can be used to monitor generation and consumption of H₂O₂.

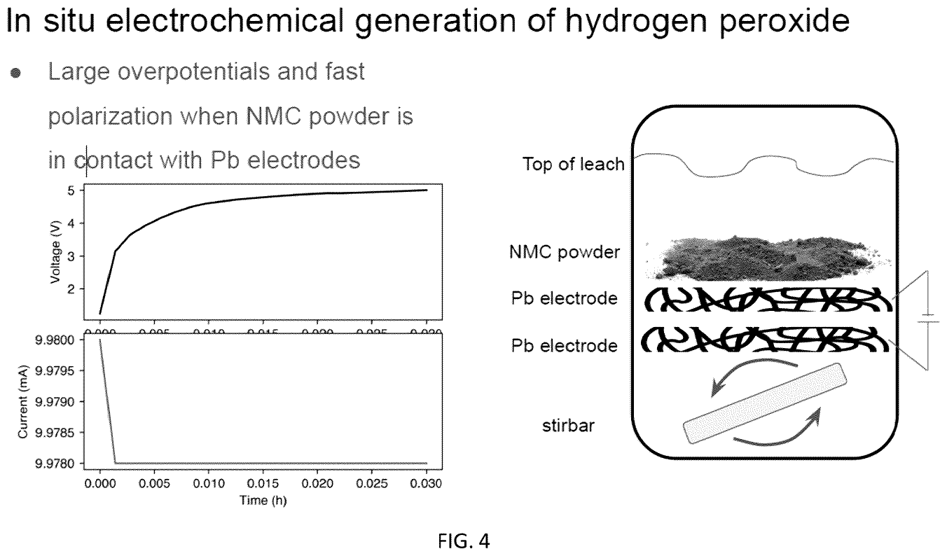

FIG. 4 provides example results from a system according to the present disclosure in which the nickel manganese cobalt (NMC) powder being processed is in contact with one of the PbO₂ electrodes of the system. As shown, a stirrer or other agitator can be present to facilitate system operation.

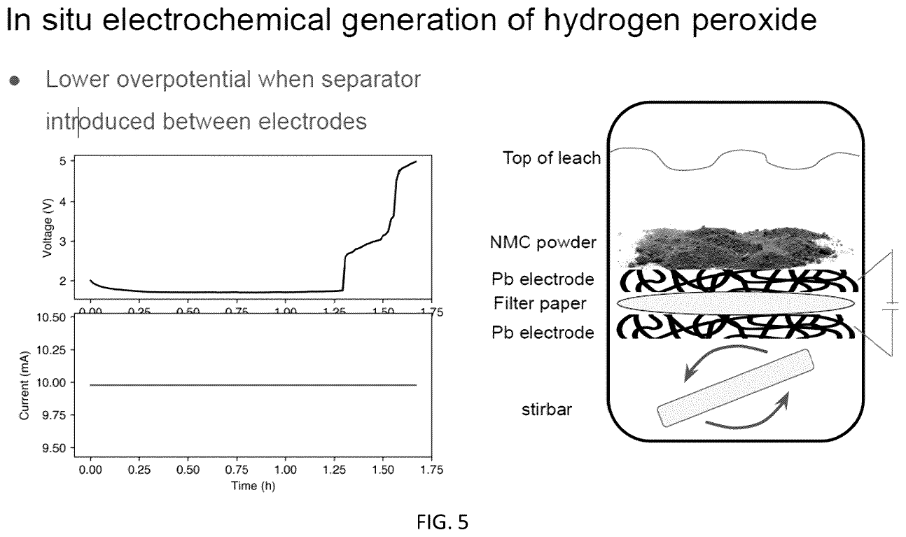

FIG. 5 provides example results from a system according to the present disclosure in which the NMC powder being processed is in contact with one of the electrodes of the system and a separator is disposed between the two electrodes of the system. Such a separator can be pervious; as an example, such a separator can be filter paper or other pervious separator. Without being bound to any particular theory or embodiment, the presence of a separator can reduce the overpotential, particularly when the separator is present between electrodes.

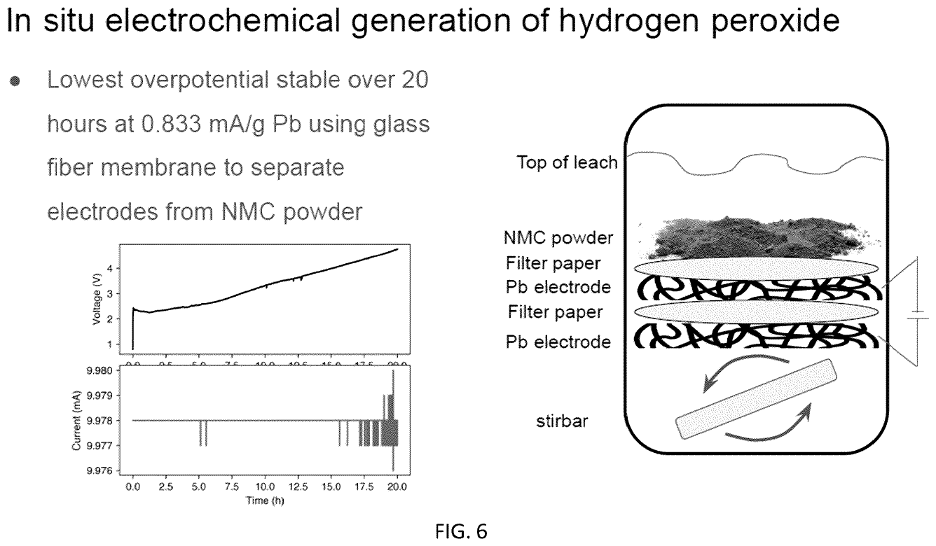

FIG. 6 provides example results from a system according to the present disclosure in which the NMC powder being processed is separated from the electrodes of the system and a separator also is disposed between the two electrodes of the system. Without being bound to any particular theory or embodiment, the presence of a separator can reduce the overpotential, particularly when the separator is present between electrodes and when the separator is present between the feed material and an electrode, as shown in FIG. 6.

### REFERENCES

1. Dutta T, Kim K -H, Uchimiya M, Kwon E E, Jeon B -H, Deep A, Yun S -T (2016) Global demand for rare earth resources and strategies for green mining. Environmental research, 150:182-190. https://doi.org/10.1016/j.envres.2016.05.052
2. Schlesinger M, King M, Sole K, Davenport W (2011) Extractive Metallurgy of Copper. https://doi.org/10.1016/C2010-0-64841-3
3. Gielen D, Saygin D, Taibi E, Birat J -P (2020) Renewables-based decarbonization and relocation of iron and steel making: A case study. Journal of Industrial Ecology, 24(5):1113-1125. https://doi.org/10.1111/jiec.12997
4. Schmidt H G (2022) Safe Piranhas: A Review of Methods and Protocols. ACS Chemical Health & Safety, 29(1): 54-61. https://doi.org/10.1021/acs.chas.1c00094
5. Mauriz E, Calle A, Montoya A, Lechuga L M (2006) Determination of environmental organic pollutants with a portable optical immunosensor. Talanta, 69(2):359-364. https://doi.org/10.1016/j.talanta.2005.09.049
6. Gaines L, Richa K, Spangenberger J (2018) Key issues for Li-ion battery recycling. MRS Energy & Sustainability, 5:E14. https://doi.org/10.1557/mre.2018.13
7. Jung Y S, Lim W T, Park J -Y, Kim Y -H (2009) Effect of pH on Fenton and Fenton-like oxidation. Environmental technology, 30(2):183-190. https://doi.org/10.1080/09593330802468848
8. Babuponnusami A, Muthukumar K (2014) A review on Fenton and improvements to the Fenton process for wastewater treatment. Journal of Environmental Chemical Engineering, 2(1):557-572. https://doi.org/10.1016/j.jece.2013.10.011
9. Seo D C, Jeon I, Jeong E S, Jho J Y (2020) Mechanical Properties and Chemical Durability of Nafion/Sulfonated Graphene Oxide/Cerium Oxide Composite Membranes for Fuel-Cell Applications. Polymers, 12(6)https://doi.org/10.3390/polym12061375
10. Wang N, Zheng T, Zhang G, Wang P (2016) A review on Fenton-like processes for organic wastewater treatment. Journal of Environmental Chemical Engineering, 4(1):762-787. https://doi.org/10.1016/j.jece.2015.12.016
11. Kołodziej B, Adamski Z (1985) Effect of manganese (II) added to the electrolyte on the properties of lead anodes used in oxidation of ferrous sulphate to ferric sulphate. Journal of Applied Electrochemistry, 15(5):705-710. https://doi.org/10.1007/BF00620566

What is claimed:

1. A method, comprising:
in the presence of an acid, applying a current between a first electrode and a second electrode so as to form an amount of hydrogen peroxide in situ so as to give rise to a digesting solution that comprises hydrogen peroxide and the acid;
contacting the digesting solution and a metallic composition comprising a metal so as dissolve at least some of the metal comprised in the metallic composition, the metal optionally being a transition metal; and
collecting at least some of the metal dissolved from the metallic composition.

2. The method of claim 1, wherein at least one of the first electrode and the second electrode comprises PbO₂.

3. The method of claim 1, wherein the acid comprises sulfuric acid.

4. The method of claim 1, wherein the metal comprises any one or more of nickel, manganese, and cobalt.

5. The method of claim 1, further comprising collecting the metallic composition from a battery.

6. The method of claim 1, wherein fluid motion is restricted (i) between the metallic composition and one of the first and second electrodes, (ii) between the first and second electrodes, or both (i) and (ii).

7. The method of claim 6, wherein a pervious medium restricts the fluid motion.

8. The method of claim 1, wherein the method is performed under such conditions that the first and second electrodes remain essentially structurally intact during performance of the method.

9. The method of claim 1, wherein the method is performed in a continuous manner.

10. A system, comprising:
a container;
a first electrode and a second electrode,
the first electrode and the second electrode being disposed within the container,
at least one of the first electrode and the second electrode comprising PbO₂; and
an amount of acid disposed in the container.

11. The system of claim 10, wherein the acid comprises sulfuric acid.

12. The system of claim 10, further comprising an amount of a metallic composition disposed in the container.

13. The system of claim 12, wherein the metallic composition comprises a transition metal.

14. The system of claim 12, further comprising a pervious medium (i) between the metallic composition and one of the first and second electrodes, (ii) between the first and second electrodes, or both (i) and (ii).

15. The system of claim 10, further comprising an outlet for communicating dissolved material evolved in the container.

16. A method, comprising:
forming hydrogen peroxide in situ and contacting the hydrogen peroxide and an acid to form a digesting solution;
contacting the digesting solution and a metallic composition that comprises a metal so as to dissolve the metal, the metal optionally being a transition metal; and
collecting at least some of the dissolved metal.

17. The method of claim 16, wherein the digesting solution is free or essentially free of exogenous hydrogen peroxide.

18. The method of claim 16, wherein forming the hydrogen peroxide in situ is effected electrochemically by applying a current between first and second electrodes, the first and second electrodes comprising PbO₂.

19. The method of claim 16, wherein the metallic composition is obtained from a battery.

20. The method of claim 16, wherein the dissolved metal comprises any one or more of nickel, manganese, and cobalt.
